(19) United States
(12) Patent Application Publication
(10) Pub. No.: US 2025/0381550 A1
(43) Pub. Date: Dec. 18, 2025

(54) CARBON DISULFIDE TREATED MATERIALS AND METHODS OF PURIFYING FLUIDS USING THE SAME

(71) Applicant: Zenith Purification, LLC, Missouri City, TX (US)

(72) Inventor: Jian J. ZOU, Sugar Land, TX (US)

(21) Appl. No.: 18/877,878

(22) PCT Filed: Jul. 6, 2023
(86) PCT No.: PCT/US2023/026988

§ 371 Date: Dec. 20, 2024

Related U.S. Application Data
(60) Provisional application No. 63/359,159, filed on Jul. 7, 2022.

(51) Int. Cl. B01J 20/22; B01J 20/10; B01J 20/32; C02F 1/28; C02F 101/20

(52) U.S. Cl. CPC B01J 20/22; B01J 20/103; B01J 20/3204; B01J 20/3261; C02F 1/288; C02F 1/281; C02F 1/285; C02F 2101/20

(57) ABSTRACT

Embodiments of the present disclosure generally relate to organosilane compounds, methods for preparing the organosilane compounds, and products which contain the organosilane compounds. In one or more embodiments, one or more of the organosilane compounds are represented by Formulas (5a), (5b), (5c), (5d), (5e), (5f), (6), (7), (8), (9), (10), (13), (14), (15), (16), (17), and (18). In other embodiments, one or more methods for preparing the organosilane compounds are described and disclosed herein. In some embodiments, one or more products, such as a functionalized inorganic matrix containing the organosilane compound disposed on an inorganic support media (e.g., silica), are described and disclosed herein.

### BACKGROUND

### Field

Embodiments of the present disclosure generally relate to silanes, and more specifically, organosilane compounds, methods for preparing the same, and products which contain the same.

### Description of the Related Art

Inorganic materials have been used as support media to remove heavy metals or support heavy metal catalysts. However, the surfaces of untreated inorganic materials such as silica and glass have a limited affinity for heavy metals and little to no selectivity for a specific heavy metal. Various organic and other compounds have been used to treat inorganic materials to promote adhesion between inorganic materials and organic materials. Some of these compounds have been reported to treat inorganic materials to increase the surface affinity for heavy metals. However, the high costs, limited adsorption capacities, and low selectivity have restricted their use. There is a growing need in the field for additional materials, compositions, and processes that can further enhance the surface affinity for heavy metals and selectivity towards various heavy metals.

Therefore, there is need for improved organosilanes, methods for making the same, and products and systems containing such for organosilanes.

### SUMMARY

Embodiments of the present disclosure generally relate to organosilane compounds, methods for preparing the organosilane compounds, and products which contain the organosilane compounds. In one or more embodiments, the organosilane compounds have one or more dithiocarbamate ester groups and can be used to couple to metal (e.g., heavy metal) in various fluids including liquids and/or gases. In some embodiments, the organosilane compounds can be prepared from organosilanes (aminosilanes and halogensilanes) and carbon disulfide. In other embodiments, functionalized inorganic matrixes containing the organosilane compounds can be prepared and used as adsorbent materials and filter materials.

In one or more embodiments, the organosilane compound is represented by one or more of Formulas (5a), (5b), (5c), (5d), (5e), or (5f):

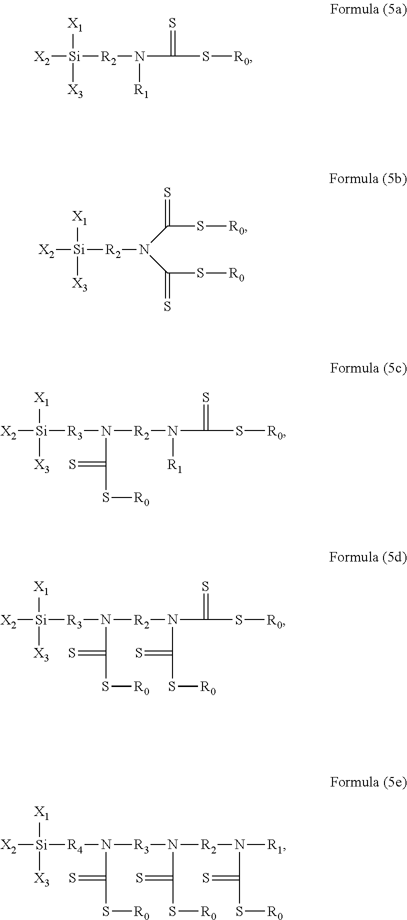

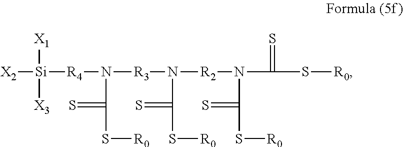

where each of X₁, X₂, and X₃ is independently a hydrolysable group selected from an alkoxy group, an acyloxy group, a halogen, or a hydride; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10. In one or more examples, the organosilane compound is represented by one or more of Formulas (6), (7), (8), (9), and (10).

In other embodiments, a method of preparing the organosilane compounds represented by one or more of Formulas (5a)-(5f) and (6)-(10) is provided and includes combining an aminosilane, an alkyl halide, carbon disulfide, a base, a solvent, and an optional phase-transfer catalyst to produce the organosilane compound, wherein: the aminosilane is represented by Formulas (11a), (11b), and (11c) and the alkyl halide is represented by Formula (12):

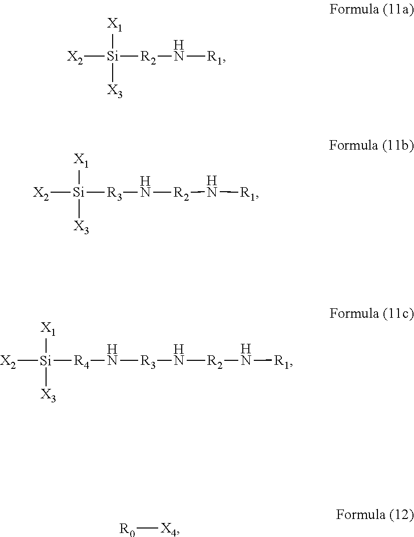

where each of X₁, X₂, and X₃ is independently a hydrolysable group selected from an alkoxy group, an acyloxy group, a halogen, or a hydride; X₄ is fluoride, chloride, bromide, or iodide; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.

In one or more embodiments, a functionalized inorganic matrix comprising an inorganic support media and the organosilane compound represented by one or more of Formulas (5a)-(5f) and (6)-(10), wherein the organosilane compound is disposed on a surface of the inorganic support media. In some embodiments, a method of preparing a functionalized inorganic matrix comprising the organosilane compound represented by one or more of Formulas (5a)-(5f) and (6)-(10) is provided and includes combining the organosilane compound, an optional solvent, water, and an acid to form a mixture having a pH value of about 1.0 to about 6.0; exposing an inorganic support media to the mixture; and drying the mixture on the inorganic support media to form the functionalized inorganic matrix. In other embodiments, a filter system comprising the functionalized inorganic matrix contained in a filter unit is described and discussed herein as related to the organosilane compound represented by one or more of Formulas (5a)-(5f) and (6)-(10).

In one or more embodiments, the organosilane compound is represented by Formula (13):

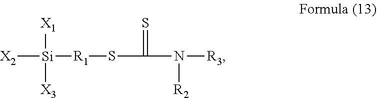

where each of X₁, X₂, and X₃ is independently a hydrolysable group selected from an alkoxy group, an acyloxy group, a halide, or a hydride; R₁ is selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and each of R₂ and R₃ is independently selected from a hydrogen, a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10. In one or more examples, the organosilane compound is represented by one or more of Formulas (14), (15), (16), (17), and (18).

In some embodiments, a method of preparing the organosilane compounds represented by one or more of Formulas (13)-(18) is provided and includes combining a halogensilane, an amine-containing compound, carbon disulfide, a base, a solvent, and a phase-transfer catalyst to produce the organosilane compound, wherein: the halogensilane is represented by Formula (19) and the amine-containing compound is represented by Formula (20):

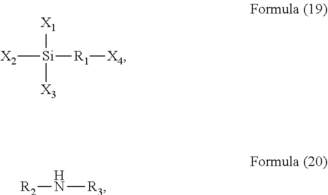

where each of X₁, X₂, and X₃ is independently a hydrolysable group selected from an alkoxy group, an acyloxy group, a halide, or a hydride; X₄ is fluoride, chloride, bromide, or iodide; R₁ is selected from a saturated or unsaturated, linear or branched, substituted or unsubstituted, hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and each of R₂ and R₃ is independently is selected from a hydrogen; a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; a linear or branched hydrocarbon chain with at least one hydroxyl group wherein the number of carbon atoms ranges from 1 to 10; or a linear or branched hydrocarbon chain with at least one amino group wherein the number of carbon atoms ranges from 1 to 10.

In some embodiments, a functionalized inorganic matrix is provided and contains an inorganic support media and the organosilane compound represented by one or more of Formulas (13)-(18), where the organosilane compound is disposed on a surface of the inorganic support media. In other embodiments, a method of preparing a functionalized inorganic matrix comprising the organosilane compound represented by one or more of Formulas (13)-(18) is provided and includes combining the organosilane compound, an optional solvent, water, and an acid to form a mixture having a pH value of about 1.0 to about 6.0; exposing an inorganic support media to the mixture; and drying the mixture on the inorganic support media to form the functionalized inorganic matrix. In other embodiments, a filter system comprising the functionalized inorganic matrix contained in a filter unit is described and discussed herein as related to the organosilane compound represented by one or more of Formulas (13)-(18).

In one or more embodiments, a method for preparing a functionalized inorganic matrix is provided and includes combining an inorganic support media, an amine-containing silane, water, an acid, carbon disulfide, one or more solvents, an optional base, and an optional alkyl halide to produce the functionalized inorganic matrix, wherein the amine-containing silane is represented by Formula (21a), Formula (21b), or Formula (21b); and the optional alkyl halide is represented by Formula (22):

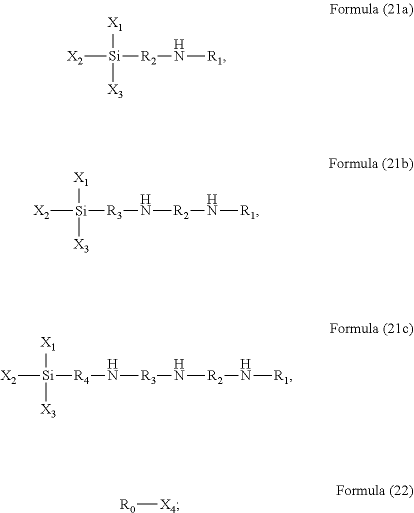

where each of X₁, X₂, and X₃ is independently a hydrolysable group selected from an alkoxy group, an acyloxy group, a halide, or a hydride; X₄ is fluoride, chloride, bromide, or iodide; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.

In some examples, the amine-containing silane represented by Formula (21a)-(21c) can be or include 3-aminopropyltriethoxysilane, 3-aminopropyltrimethoxysilane, 4-aminobutyltriethoxysilane, 4-amino-3,3-dimethylbutyltrimethoxysilane, n-(2-aminoethyl)-3-aminopropyltriethoxysilane, 3-(m-aminophenoxy) propyltrimethoxysilane, aminophenyltrimethoxysilane, aminophenyltriethoxysilane, 3-aminopropyltris(methoxyethoxyethoxy) silane, 11-aminoundecyltriethoxysilane, 3-aminopropylsilanetriol, 4-amino-3,3-dimethylbutylmethyldimethoxysilane, 3-aminopropylmethyldiethoxysilane, 1-amino-2-(dimethylethoxysilyl)propane, 3-aminopropyldiisopropylethoxysilane, n-(2-aminoethyl)-3-aminopropyltrimethoxysilane, n-(6-aminohexyl)aminomethyltriethoxysilane, n-(2-aminoethyl)-11-aminoundecyltrimethoxysilane, n-(2-aminoethyl)-3-aminopropylsilanetriol, n-(2-aminoethyl)-3-aminoisobutylmethyldimethoxysilane, n-(2-aminoethyl)-3-aminopropylmethyldiethoxysilane, n-(2-aminoethyl)-3-aminopropylmethyldimethoxysilane, (3-trimethoxysilylpropyl) diethylenetriamine, n-(2-aminoethyl)-3-aminoisobutyldimethylmethoxysilane, 3-(n-allylamino) propyltrimethoxysilane, n-butylaminopropyltrimethoxysilane, t-butylaminopropyltrimethoxysilane, (3-(n-ethylamino)isobutyl)methyldiethoxysilane, (3-(n-ethylamino)isobutyl)trimethoxysilane, n-methylaminopropylmethyldimethoxysilane, n-methylaminopropyltrimethoxysilane, (phenylaminomethyl)methyldimethoxysilane, n-phenylaminomethyltriethoxysilane, n-phenylaminopropyltrimethoxysilane, or any combination thereof.

In some embodiments, the method for preparing the functionalized inorganic matrix is provided and further includes combining the amine-containing silane, a first solvent, the water, and the acid to form a first mixture having a pH value of about 1.0 to about 6.0; exposing the inorganic support media to the first mixture; at least partially drying the first mixture on the inorganic support media to form an intermediate product; and exposing the intermediate product to a second mixture comprising a second solvent, carbon disulfide, and the base to produce the functionalized inorganic matrix.

In one or more embodiments, method of preparing a functionalized inorganic matrix is provided and includes combining an inorganic support media, a silane, water, an acid, and a solvent to produce the functionalized inorganic matrix, wherein the silane is selected from 3-thiocyanatopropyltriethoxysilane, 3-thiocyanatopropyltrimethoxysilane, 3-octanoylthio-1-propyltriethoxysilane, 3-octanoylthio-1-propyltrimethoxysilane, and an organosilane represented by Formula (23):

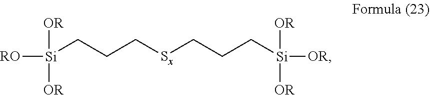

where x is in a range from 1.0 to 8.0 and each R is independently a methyl group or an ethyl group.

### DETAILED DESCRIPTION

Embodiments of the present disclosure generally relate to organosilane compounds, methods for preparing the organosilane compounds, and products which contain the organosilane compounds. In one or more embodiments, the organosilane compounds have one or more dithiocarbamate ester groups and can be used to couple to metal (e.g., heavy metal) in various fluids including liquids and/or gases. In some embodiments, the organosilane compounds can be prepared from organosilanes (aminosilanes and halogensilanes) and carbon disulfide. In other embodiments, functionalized inorganic matrixes containing the organosilane compounds can be prepared and used as adsorbent materials and filter materials. In some examples, adsorbents and/or filters, and using the same adsorbents and filters to remove metals, including heavy metals, and to purify fluids such as gases and liquids, and to support metal catalysts.

In one or more embodiments, one or more dithiocarbamate compounds are represented by Formula (1):

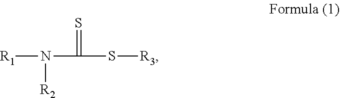

where each R₁, R₂, and R₃ is independently an alkyl group or hydrogen. These dithiocarbamate compounds are a precursor for preparing the organosilane compounds containing one or more dithiocarbamate groups, as described and discussed herein. The organosilane compounds containing dithiocarbamate can be prepared by multiple methods or pathways represented by Schemes (A)-(E) provided below. In one or more embodiments, the method includes mixing an aminosilane with carbon disulfide and an alkyl halide while continuously removing the by-product, hydrogen halide, as represented in Schemes (A), (B), and (C). In other embodiments, the method includes mixing a halogensilane with carbon disulfide and an amine-containing compound while continuously removing the by-product, hydrogen halide, as represented in Schemes (D) and (E).

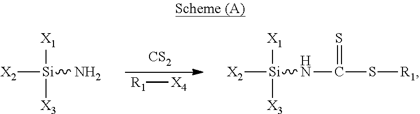

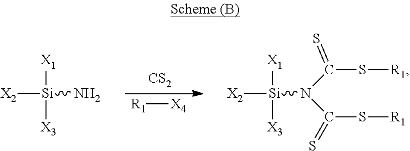

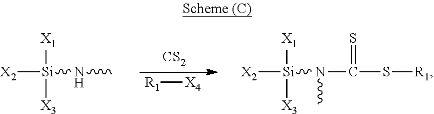

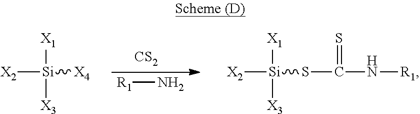

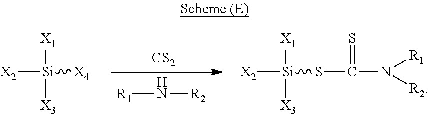

In the Schemes (A), (B), (C), (D), and (E), each of X₁, X₂, and X₃ is independently a hydrolysable group selected from an alkoxy group, an acyloxy group, a halogen (e.g., F, Cl, Br, or I), or a hydride, X₄ is fluoride, chloride, bromide, or iodide, and R₁ and R₂ are alkyl groups or linear or branched hydrocarbon chains with at least one hydroxyl group. The by-product, hydrogen halide, from Schemes (A), (B), (C), (D), and (E) could be continuously removed or neutralized by an optional base including sodium hydroxide, sodium ethylate, sodium methylate, potassium hydroxide, sodium carbonate, and sodium bicarbonate. Exemplary alkyl halides for Scheme (A), (B), and (C) can be or include benzyl chloride, methyl 2-bromoacetate, other halides thereof, or any combination thereof. It is optional to use a solvent or a mixture of solvents for Schemes (A), (B), (C), (D), and (E). Exemplary solvents can be or include one or more of water, methanol, ethanol, isopropyl alcohol, propyl alcohol, tetrahydrofuran, ethyl acetate, ethylene glycol, diethylene glycol, ethylene carbonate, propylene carbonate, pyridine, or any combination thereof. In the Schemes (A), (B), (C), (D), and (E), an optional phase-transfer catalyst can be used to facilitate the reaction.

In one or more embodiments, the amino-containing silanes or aminosilanes that can be used in the Schemes (A), (B), and (C) can be or include one or more silanes with at least one, two, or three hydrolysable groups and at least one amine group. Some examples of aminosilanes are represented by Formulas (2a), (2b), and (2c).

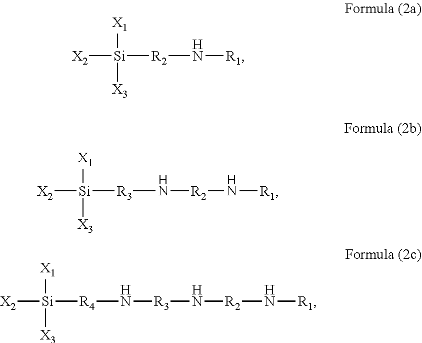

where each of X₁, X₂, and X₃ is independently a hydrolysable group selected from an alkoxy group, an acyloxy group, a halogen (e.g., F, Cl, Br, I), or a hydride. Each R₁ is independently selected from hydrogen, a linear or branched alkyl group wherein the number of carbon atoms ranges from 1 to 10, a cyclic alkyl group wherein the number of carbon atoms ranges from 3 to 10, an aromatic group wherein the number of carbon atoms ranges from 6 to 10, a saturated or unsaturated heterocyclic group wherein the number of carbon atoms ranges from 3 to 10 and the number of heteroatoms in the heterocyclic ring of the heterocyclic group is 1, 2, or 3, or an alkylamino group wherein the number of carbon atoms ranges from 1 to 10. Each of R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.

Exemplary amino-containing silanes or aminosilanes include 3-aminopropyltrimethoxysilane, 3-aminopropyltriethoxysilane, 3-aminopropylmethyldiethoxysilane, N-(2-aminoethyl)-3-aminopropyltrimethoxysilane, N-(2-aminoethyl)-3-aminopropyltriethoxysilane, [3-(N-ethylamino)isobutyl] trimethoxysilane, N-methylaminopropyltrimethoxysilane, 3-aminopropylsilanetriol, (3-trimethoxysilylpropyl) diethylenetriamine, and 4-amino-3,3-dimethylbutyltrimethoxysilane.

In one or more embodiments, organosilane compounds containing dithiocarbamate can be prepared by the method represented in Scheme (A), Scheme (B), and Scheme (C). The preparation process includes (a) mixing an aminosilane with carbon disulfide, an alkyl halide, an optional base, an optional solvent, and an optional phase-transfer catalyst at about −10° C. to about 100° C. and about 0.147 pound per square inch (psi) to about 147 psi, for a total of about 0.5 hours to about 48 hours; (b) separate the two phases, (c) wash the resulting silane in the top phase with water for one or multiple times. The molar ratio of the amino groups in the aminosilane, the carbon disulfide, the alkyl halide, the optional base (when present), and the optional phase-transfer catalyst (when present) range from about 1:0.1:0.05:0.1:0.0000001 to about 1:8:8:8:0.0000002. When the optional base is not used, the by-product, hydrogen halide, is continuously removed from the reactor system with nitrogen purge or vacuum.

In one or more embodiments, the halogensilanes can be in the Schemes (D) and (E) include one or more silanes with at least one hydrolysable group and at least one halide. The halide is fluoride, chloride, bromide, or iodide. Some examples are represented in Formulas (3) and (4):

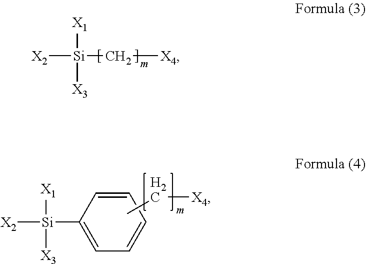

where at least one of X₁, X₂, X₃ is hydrolysable, m is an integer in a range from 1 to 18. Hydrolysable group include one or more of alkoxy, acyloxy, halogen, or hydride. X₄ is fluoride, chloride, bromide, or iodide.

In one or more embodiments, organosilane compounds containing dithiocarbamate can be prepared by the method represented in Scheme (D) and Scheme (E). The preparation process includes (a) mixing a halogensilane with carbon disulfide, an amine-containing compound, an optional base, an optional solvent, and an optional phase-transfer catalyst at about −10° C. to about 100° C. and about 0.147 pound per square inch (psi) to about 147 psi, for a total of about 0.5 to about 48 hours; (b) separate the two phases, (c) wash the resulting silane in the product phase with water for one or multiple times. The molar ratio of the amino groups in the halogensilane, the carbon disulfide, the amine-containing compound, the optional base, and the optional phase-transfer catalyst range from about 1:0.1:0.05:0.1:0.0000001 to about 1:4:4:4:0.0000002. When the optional base is not used, the by-product, hydrogen halide, is continuously removed from the reactor system with nitrogen purge or vacuum.

In one or more embodiments, one or more organosilane compounds are represented by Formulas (5a), (5b), (5c), (5d), (5e), (5b), or (5f):

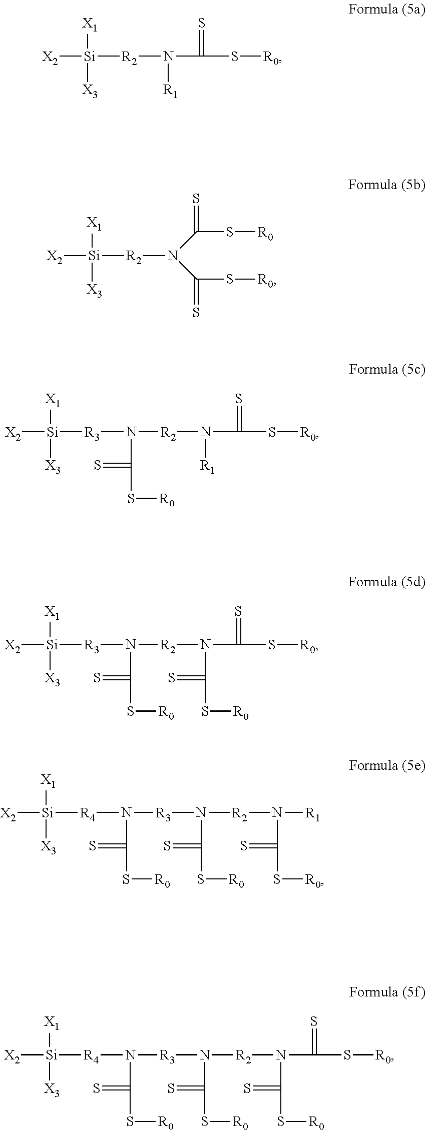

where each of X₁, X₂, and X₃ is independently a hydrolysable group selected from an alkoxy group, an acyloxy group, a halogen, or a hydride. Each R₁ is independently selected from hydrogen; a linear or branched alkyl group wherein the number of carbon atoms ranges from 1 to 10, a cyclic alkyl group wherein the number of carbon atoms ranges from 3 to 10, an aromatic group wherein the number of carbon atoms ranges from 6 to 10, a saturated or unsaturated heterocyclic group wherein the number of carbon atoms ranges from 3 to 10 and the number of heteroatoms in the heterocyclic ring of the heterocyclic group is 1, 2, or 3, or an alkylamino group wherein the number of carbon atoms ranges from 1 to 10. Each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.

In one or more examples, the organosilane compound represented by Formula (5a) is represented by Formula (6):

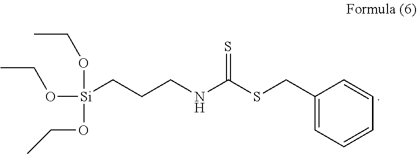 [SMILES: CCO[Si](CCCNC(=S)SCc1ccccc1)(OCC)OCC]

In some examples, the organosilane compound represented by Formula (5a) is represented by Formula (7):

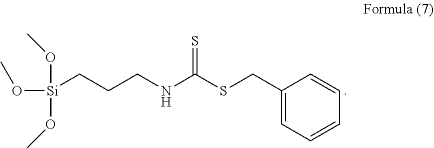 [SMILES: CO[Si](CCCNC(=S)SCc1ccccc1)(OC)OC]

In other examples, the organosilane compound represented by Formula (5a) is represented by Formula (8):

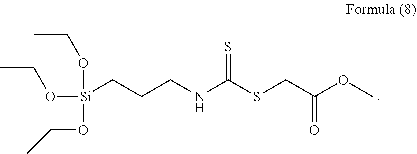 [SMILES: CCO[Si](CCCNC(=S)SCC(=O)OC)(OCC)OCC]

In one or more examples, the organosilane compound represented by Formula (5a) is represented by Formula (9):

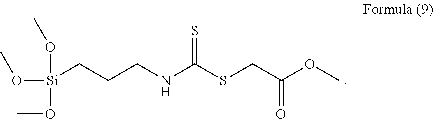

In some examples, the organosilane compound represented by Formula (5b) is represented by Formula (10):

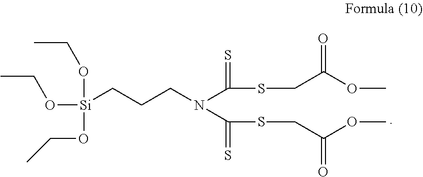 [SMILES: CCO[Si](CCCN(C(=S)SCC(=O)OC)C(=S)SCC(=O)OC)(OCC)OCC]

In one or more embodiments, a method of preparing the organosilane compound represented by Formulas (5a), (5b), (5c), (5d), (5e), (5f), (6), (7), (8), (9), and (10) is provided an includes combining an aminosilane, an alkyl halide, carbon disulfide, a base, a solvent, and an optional phase-transfer catalyst to produce the organosilane compound. The aminosilane is represented by Formulas (11a), (11b), and (11c) and the alkyl halide is represented by Formula (12):

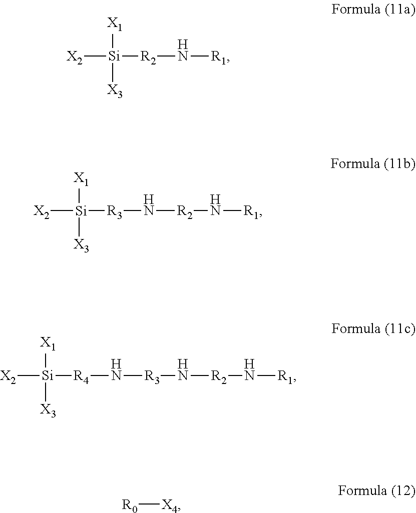

where each of X₁, X₂, and X₃ is independently a hydrolysable group selected from an alkoxy group, an acyloxy group, a halogen, or a hydride, and X₄ is fluoride, chloride, bromide, or iodide. Each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10. Each of R₀, R₂, R₃, and R₄ is independently selected from a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.

The base can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, or any combination thereof. The solvent can be or include methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof. The phase-transfer catalyst can be or include tributyl(tetradecyl) phosphonium chloride, trioctyl(octadecyl) phosphonium iodide, tetramethylammonium chloride, tetramethylammonium bromide, tetramethylammonium iodide, tetramethylammonium hydroxide, tetraethylammonium chloride, tetraethylammonium bromide, tetraethylammonium iodide, tetraethylammonium hydroxide, tetrabutylammonium chloride, tetrabutylammonium bromide, tetrabutylammonium iodide, tetrabutylammonium hydroxide, methyltributylammonium chloride, methyltributylammonium bromide, methyltributylammoniumiodide, methyltributylammonium hydroxide, tetraoctylammonium chloride, tetraoctylammonium bromide, tetraoctylammonium iodide, tetraoctylammonium hydroxide, methyltrioctylammonium chloride, methyltrioctylammonium bromide, methyltrioctylammonium iodide, methyltriocty lammonium hydroxide, benzyltrimethylammonium chloride, benzyltrimethylammonium bromide, benzyltriethylammonium chloride, benzyltributylammonium chloride, dibenzyldimethylammonium chloride, dibenzyldimethylammonium bromide, dibenzyldiethylammonium chloride, dibenzyldibutylammonium chloride, tetrabutylphosphonium bromide, tetrabutylphosphonium chloride, aqueous solutions thereof, or any combination thereof.

In some embodiments, a method of preparing a functionalized inorganic matrix containing one or more of the organosilane compounds represented by one or more of Formulas (5a), (5b), (5c), (5d), (5e), (5f), (6), (7), (8), (9), and (10). The method is provided and includes combining the organosilane compound, an optional solvent, water, and an acid to form a mixture having a pH value of about 1.0 to about 6.0, exposing an inorganic support media to the mixture, and drying the mixture on the inorganic support media to form the functionalized inorganic matrix. In some examples, the inorganic support media is exposed to the mixture by: dipping or submerging the inorganic support media into the mixture, or spraying the mixture on to the inorganic support media by a one or more techniques selected from ultrasonic nebulization, pressure atomization, or electrostatic atomization. Examples of the inorganic support media can be or include silica, quartz, glass, sand, diatomite, aluminum oxide, alumina, aluminosilicate, metallic substrates, iron substrates, aluminum substrates, or any combination thereof.

In one or more embodiments, one or more organosilane compounds are represented by Formula (13):

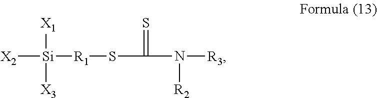

where each of X₁, X₂, and X₃ is independently a hydrolysable group selected from an alkoxy group, an acyloxy group, a halide (e.g., F, Cl, Br, or I), or a hydride. R₁ is selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3. Each of R₂ and R₃ is independently selected from a hydrogen, a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.

In one or more examples, the organosilane compound represented by Formula (13) is represented by Formula (14):

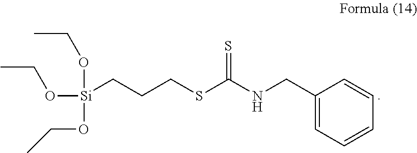 [SMILES: CCO[Si](CCCSC(=S)NCc1ccccc1)(OCC)OCC]

In other examples, the organosilane compound represented by Formula (13) is represented by Formula (15):

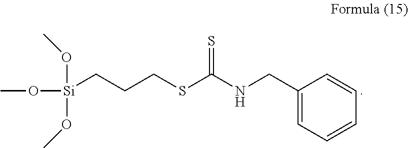 [SMILES: CO[Si](CCCSC(=S)NCc1ccccc1)(OC)OC]

In some examples, the organosilane compound represented by Formula (13) is represented by Formula (16):

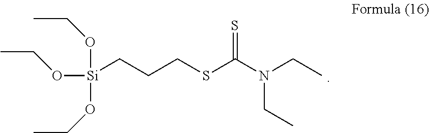 [SMILES: CCO[Si](CCCSC(=S)N(CC)CC)(OCC)OCC]

In one or more examples, the organosilane compound represented by Formula (13) is represented by Formula (17):

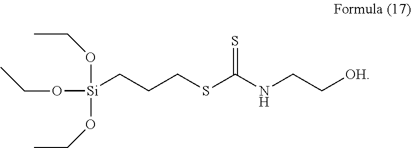 [SMILES: CCO[Si](CCCSC(=S)NCCO)(OCC)OCC]

In other examples, the organosilane compound represented by Formula (13) is represented by Formula (18):

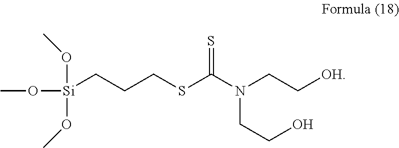 [SMILES: CO[Si](CCCSC(=S)N(CCO)CCO)(OC)OC]

In one or more embodiments, a method of preparing the organosilane compounds represented by Formulas (13), (14), (15), (16), (17), and (18) is provided an includes combining a halogensilane, an amine-containing compound, carbon disulfide, a base, a solvent, and a phase-transfer catalyst to produce the organosilane compound. The halogensilane is represented by Formula (19) and the amine-containing compound is represented by Formula (20):

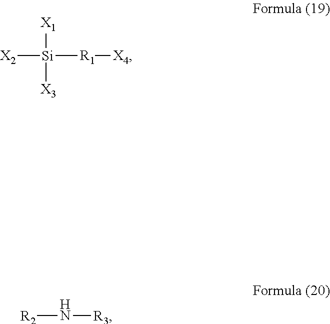

where each of X₁, X₂, and X₃ is independently a hydrolysable group selected from an alkoxy group, an acyloxy group, a halide, or a hydride and X₄ is fluoride, chloride, bromide, or iodide. R₁ is selected from a saturated or unsaturated, linear or branched, substituted or unsubstituted, hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3. Each of R₂ and R₃ is independently is selected from a hydrogen; a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; a linear or branched hydrocarbon chain with at least one hydroxyl group wherein the number of carbon atoms ranges from 1 to 10; or a linear or branched hydrocarbon chain with at least one amino group wherein the number of carbon atoms ranges from 1 to 10.

The amine-containing compound can be or include ammonia, monoethanolamine, diethanolamine, diisopropanolamine, diglycolamine, iminodiacetic acid, or any combination thereof. The base can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, or any combination thereof. The solvent can be or include methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof. The phase-transfer catalyst can be or include tributyl(tetradecyl) phosphonium chloride, trioctyl(octadecyl) phosphonium iodide, tetramethylammonium chloride, tetramethylammonium bromide, tetramethylammonium iodide, tetramethylammonium hydroxide, tetraethylammonium chloride, tetraethylammonium bromide, tetraethylammonium iodide, tetraethylammonium hydroxide, tetrabutylammonium chloride, tetrabutylammonium bromide, tetrabutylammonium iodide, tetrabutylammonium hydroxide, methyltributylammonium chloride, methyltributylammonium bromide, methyltributylammoniumiodide, methyltributylammonium hydroxide, tetraoctylammonium chloride, tetraoctylammonium bromide, tetraoctylammonium iodide, tetraoctylammonium hydroxide, methyltrioctylammonium chloride, methyltrioctylammonium bromide, methyltrioctylammonium iodide, methyltriocty lammonium hydroxide, benzyltrimethylammonium chloride, benzyltrimethylammonium bromide, benzyltriethylammonium chloride, benzyltributylammonium chloride, dibenzyldimethylammonium chloride, dibenzyldimethylammonium bromide, dibenzyldiethylammonium chloride, dibenzyldibutylammonium chloride, tetrabutylphosphonium bromide, tetrabutylphosphonium chloride, aqueous solutions thereof, or any combination thereof.

In other embodiments, a method of preparing a functionalized inorganic matrix containing the organosilane compound represented by one or more of Formulas (13), (14), (15), (16), (17), and (18), is provided and includes combining the organosilane compound, an optional solvent, water, and an acid to form a mixture having a pH value of about 1.0 to about 6.0, exposing an inorganic support media to the mixture, and drying the mixture on the inorganic support media to form the functionalized inorganic matrix. The inorganic support media is exposed to the mixture by: dipping or submerging the inorganic support media into the mixture, or spraying the mixture on to the inorganic support media. Examples of the inorganic support media can be or include silica, quartz, glass, sand, diatomite, aluminum oxide, alumina, aluminosilicate, metallic substrates, iron substrates, aluminum substrates, or any combination thereof.

In one or more embodiments, a method for preparing a functionalized inorganic matrix is provided and includes combining an inorganic support media, an amine-containing silane, water, an acid, carbon disulfide, one or more solvents, an optional base, and an optional alkyl halide to produce the functionalized inorganic matrix, wherein the amine-containing silane is represented by Formula (21a), Formula (21b), or Formula (21b); and the optional alkyl halide is represented by Formula (22):

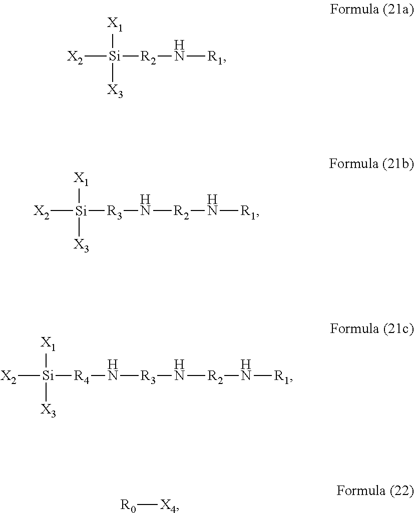

where each of X₁, X₂, and X₃ is independently a hydrolysable group selected from an alkoxy group, an acyloxy group, a halide, or a hydride, and X₄ is fluoride, chloride, bromide, or iodide. Each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10. Each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.

The amine-containing silane represented by Formula (21a)-(21c) can be or include 3-aminopropyltriethoxysilane, 3-aminopropyltrimethoxysilane, 4-aminobutyltriethoxysilane, 4-amino-3,3-dimethylbutyltrimethoxysilane, n-(2-aminoethyl)-3-aminopropyltriethoxysilane, 3-(m-aminophenoxy) propyltrimethoxysilane, aminophenyltrimethoxysilane, aminophenyltriethoxysilane, 3-aminopropyltris(methoxyethoxyethoxy) silane, 11-aminoundecyltriethoxysilane, 3-aminopropylsilanetriol, 4-amino-3,3-dimethylbutylmethyldimethoxysilane, 3-aminopropylmethyldiethoxysilane, 1-amino-2-(dimethylethoxysilyl)propane, 3-aminopropyldiisopropylethoxysilane, n-(2-aminoethyl)-3-aminopropyltrimethoxysilane, n-(6-aminohexyl)aminomethyltriethoxysilane, n-(2-aminoethyl)-11-aminoundecyltrimethoxysilane, n-(2-aminoethyl)-3-aminopropylsilanetriol, n-(2-aminoethyl)-3-aminoisobutylmethyldimethoxysilane, n-(2-aminoethyl)-3-aminopropylmethyldiethoxysilane, n-(2-aminoethyl)-3-aminopropylmethyldimethoxysilane, (3-trimethoxysilylpropyl) diethylenetriamine, n-(2-aminoethyl)-3-aminoisobutyldimethylmethoxysilane, 3-(n-allylamino) propyltrimethoxysilane, n-butylaminopropyltrimethoxysilane, t-butylaminopropyltrimethoxysilane, (3-(n-ethylamino)isobutyl)methyldiethoxysilane, (3-(n-ethylamino)isobutyl)trimethoxysilane, n-methylaminopropylmethyldimethoxysilane, n-methylaminopropyltrimethoxysilane, (phenylaminomethyl)methyldimethoxysilane, n-phenylaminomethyltriethoxysilane, n-phenylaminopropyltrimethoxysilane, or any combination thereof. The acid can be or include hydrochloric acid, sulfuric acid, phosphoric acid, nitric acid, acetic acid, boric acid, hydrofluoric acid, oxalic acid, citric acid, toluenesulfonic acid, carbonic acid, salts thereof, or any combination thereof.

In other embodiments, the method for preparing a functionalized inorganic matrix can further include combining the amine-containing silane, a first solvent, the water, and the acid to form a first mixture having a pH value of about 1.0 to about 6.0, exposing the inorganic support media to the first mixture, at least partially drying the first mixture on the inorganic support media to form an intermediate product, and exposing the intermediate product to a second mixture comprising a second solvent, carbon disulfide, and the base to produce the functionalized inorganic matrix. The second mixture further contains one or more alkyl halides (e.g., benzyl chloride and/or methyl 2-bromoacetate). The solvent can be or include methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof. The base can be or include lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, or any combination thereof.

In some examples, the inorganic support media can be exposed to the first mixture by dipping or submerging the inorganic support media into the first mixture. In other examples, the inorganic support media can be exposed to the first mixture by spraying the first mixture on to the inorganic support media. Also, in some examples, the intermediate product can be exposed to the second mixture by dipping or submerging the intermediate product into the second mixture. In other examples, the intermediate product can be exposed to the second mixture by spraying the second mixture on to the intermediate product.

Many inorganic support media have hydroxyl groups on their surfaces that can react with silanes. In one or more embodiments, these inorganic support media (a) first react with an amino-containing silane, then react with carbon disulfide and a base form the salt form of dithiocarbamate on the surfaces of the inorganic support media, or (b) first react with an amino-containing silane, then react with carbon disulfide, a base, and an alkyl halide to form dithiocarbamate on the surfaces of the inorganic support media. Scheme (F) and (G) shows the exemplary reactions with silica. It is worth noting that in theory one mole of primary amine group can react with two moles of carbon disulfide. In Scheme (F) and Scheme (G), R is an alkyl group. In Scheme (F), M can be lithium, sodium, potassium, rubidium, cesium, beryllium, magnesium, calcium, strontium, barium, or any combination thereof.

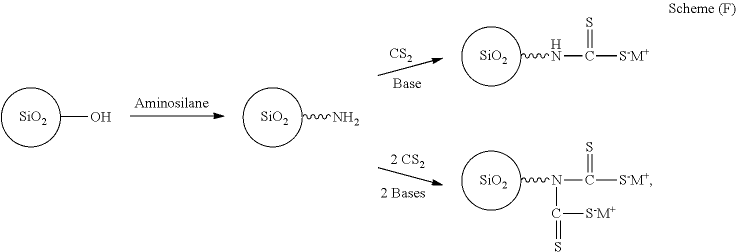

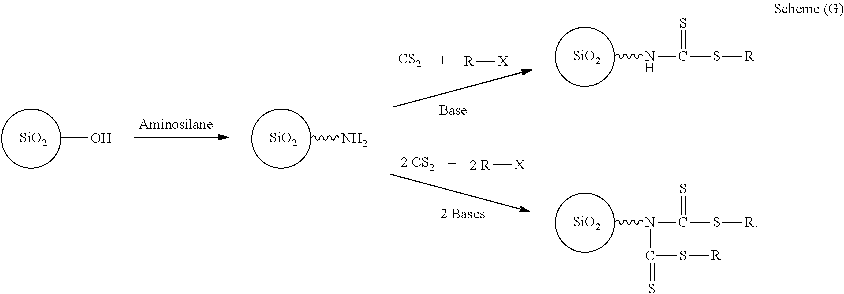

In one or more embodiments, in the chemical treatment process represented by Scheme (F), an aminosilane or a mixture of aminosilanes is mixed with a solvent or a mixture of solvents. Exemplary solvents can be or include one or more of water, methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof. The resulting solution is mixed with water and an acid to adjust the solution pH to about 1.0 to about 6.0, such as about 4.0 to about 6.0. The inorganic support media are submerged into this solution for about 0.001 hours to about 20 hours. Alternatively, the inorganic support media can be coated by spraying mists of this solution using techniques such as ultrasonic nebulization, pressure atomization, and electrostatic atomization, which are known in the field. The inorganic support media are removed from the solution by a process such as filtration or centrifuge, and rinsed with additional solvents. The inorganic support media are then dried at temperature in a range from about 10° C. to about 140° C. for about 0.1 minutes to about 48 hours. Then the inorganic support media are dipped into a base and a solvent, then with carbon disulfide being slowly added at about 10° C. to about 100° C. and about 0.147 psi to about 147 psi for about 0.001 hours to about 20 hours, removed from the solution by a process such as filtration or centrifuge, rinsed with additional solvent for one or multiple times, and dried at about 10° C. to about 200° C. and about 0.147 psi to about 147 psi for about 0.001 hours to about 20 hours.

In one or more embodiments, in the chemical treatment process represented by Scheme (G), an aminosilane or a mixture of aminosilanes is mixed with a solvent or a mixture of solvents. Exemplary solvents can be or include one or more of water, methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof. The resulting solution is mixed with water and an acid to adjust the solution pH to about 1.0 to about 6.0, such as about 4.0 to about 6.0. The inorganic support media are submerged into this solution for about 0.001 hours to about 20 hours. Alternatively, the inorganic support media can be coated by spraying mists of this solution using techniques such as ultrasonic nebulization, pressure atomization, and electrostatic atomization, which are known in the field. The inorganic support media are removed from the solution by a process such as filtration or centrifuge, and rinsed with additional solvents. The inorganic support media are then dried at temperature in a range from about 10° C. to about 140° C. for about 0.1 minutes to about 48 hours. Then the inorganic support media are dipped into a solution of carbon disulfide, an alkyl halide, and a base at about 10° C. to about 100° C. and about 0.147 psi to about 147 psi for about 0.001 hours to about 20 hours, removed from the solution by process such as filtration or centrifuge, rinsed with a solvent for one or multiple times, and dried at about 10° C. to about 200° C. and about 0.147 psi to about 147 psi for about 0.001 hours to about 20 hours.

In one or more embodiments, a method of preparing a functionalized inorganic matrix is provided and includes combining an inorganic support media, a silane, water, an acid, and a solvent to produce the functionalized inorganic matrix, wherein the silane is selected from 3-thiocyanatopropyltriethoxysilane, 3-thiocyanatopropyltrimethoxysilane, 3-octanoylthio-1-propyltriethoxysilane, 3-octanoylthio-1-propyltrimethoxysilane, and an organosilane represented by Formula (23):

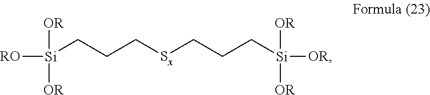

where x is in a range from 1.0 to 8.0; and each R is independently a methyl group or an ethyl group. The inorganic support media is chemically treated or otherwise functionalized by the silane. The inorganic support media can be or include silica, quartz, glass, sand, diatomite, aluminum oxide, alumina, aluminosilicate, metallic substrates, iron substrates, aluminum substrates, or any combination thereof. The acid can be or include hydrochloric acid, sulfuric acid, phosphoric acid, nitric acid, acetic acid, boric acid, hydrofluoric acid, oxalic acid, citric acid, toluenesulfonic acid, carbonic acid, salts thereof, or any combination thereof. The solvent can be or include methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, or any combination thereof.

The bridging sulfur chain or motif has a length, x in Formula (23), which can vary from about 1 to about 8, and bis(triethoxysilylpropyl) tetrasulfide and bis(triethoxysilylpropyl) disulfide refer to the silanes with sulfur chain length around 4 and 2, respectively. In some examples, the bridging sulfur chain or motif (e.g., group Sx) on any one molecule is 1, 2, 3, 4, 5, 6, 7 or 8 sulfur atoms. However, within a sample of the organosilane represented by Formula (23), the overall average stoichiometric amount of sulfur can vary between greater than 1 and less than 8, such as in a range from about 1.2, about 1.4. about 1.5, about 1.6, about 1.8, about 2, about 2.2, about 2.5 to about 2.6, about 2.8, about 3, about 3.2, about 3.5, about 3.6, about 3.8, about 4, about 4.2, about 4.5, about 4.6, about 4.8, about 5, about 6.2, about 5.5, about 6.6, about 6.8, about 7, about 7.2, about 7.5, or about 8. For example, the organosilane represented by Formula (23), the overall average stoichiometric amount is from about 1.5 to about 4.5.

In the chemical modification process using these silanes, a silane or a mixture of silanes is mixed with a mixture of solvents. Exemplary solvents can be or include one or more of water, methanol, ethanol, or any combination thereof. The resulting solution is mixed with water and an acid to adjust the solution pH to about 1.0 to about 6.0, such as about 4.0 to about 6.0. The inorganic support media are submerged into this solution for about 0.001 hours to about 20 hours. Alternatively, the inorganic support media can be coated by spraying mists of this solution using techniques such as ultrasonic nebulization, pressure atomization, and electrostatic atomization, which are known in the field. The inorganic support media are removed from the solution by a process such as filtration or centrifuge, and rinsed with additional solvents. The inorganic support media are then dried at temperature in a range from about 20° C. to about 140° C. for about 5 minutes to about 24 hours.

In one or more embodiments, a functionalized inorganic matrix comprising an inorganic support media and one of more of the organosilane compounds described and disclosed herein including one or more of the organosilane compounds represented by Formulas (5a), (5b), (5c), (5d), (5e), (5f), (6), (7), (8), (9), (10), (13), (14), (15), (16), (17), and (18), where the organosilane compound is disposed on a surface of the inorganic support media. The inorganic support media can be or contain silica, quartz, glass, sand, diatomite, aluminum oxide, alumina, aluminosilicate, metallic substrates, iron substrates, aluminum substrates, or any combination thereof. In some examples, the inorganic support media can be or contain silica, such as silica gel, amorphous silica, fumed silica, precipitated silica, or any combination thereof. In other examples, the inorganic support media can be or contain glass, such as powdered glass, glass beads, glass fibers, glass filter, non-woven glass fabric, or any combination thereof.

In one or more embodiments, a filter system is provided and includes a filter unit and a functionalized inorganic matrix disposed within and containing one of more of the organosilane compounds described and disclosed herein including one or more of the organosilane compounds represented by Formulas (5a), (5b), (5c), (5d), (5e), (5f), (6), (7), (8), (9), (10), (13), (14), (15), (16), (17), and (18). One, two, or more types of the functionalized inorganic matrix can be contained within the filter unit. In some examples, the filter system is configured to support a metal-containing catalyst (including metals which are heavy metals) or separate a heavy metal from a heavy metal-contaminated fluid by exposing the heavy metal-contaminated fluid to the functionalized inorganic matrix and producing a treated fluid and the heavy metal that is captured, or adsorbed onto the surface of the functionalized inorganic matrix.

The filter unit can include a container, a chamber, a vessel, a pipe, a conduit, or similar device for containing the functionalized inorganic matrix having one or more organosilane compounds or any other type of support containing one or more organosilane compounds. The filter unit can include one or more inlets and one or more outlets with the functionalized inorganic matrix disposed therebetween. A waste fluid, which can include a heavy metal-contaminated fluid, a metal-contaminated fluid, or another contaminated fluid, is introduced into the inlet and the treated fluid is removed from the outlet.

The heavy metal-contaminated fluid can be in a state of mater of liquid, gas, or a mixture thereof. The heavy metal-contaminated fluid can be or include water, drinking water, potable water, non-potable water, groundwater, water from oil and gas production, industrial wastewater, municipal wastewater, oil, crude oil, oil waste stream, industrial intermediate streams, product streams containing heavy metals, product streams containing heavy metal catalysts or by-products, natural gas, flue gas, synthesis gas or syngas (mixture of CO and H2), or any combination thereof. The heavy metal is selected from the group consisting of titanium, vanadium, chromium, manganese, iron, cobalt, nickel, copper, zinc, gallium, germanium, arsenic, zirconium, niobium, molybdenum, technetium, ruthenium, rhodium, palladium, silver, cadmium, indium, tin, tellurium, lutetium, hafnium, tantalum, tungsten, rhenium, osmium, iridium, platinum, gold, mercury, thallium, lead, bismuth, polonium, astatine, lanthanum, cerium, praseodymium, neodymium, promethium, samarium, europium, gadolinium, terbium, dysprosium, holmium, erbium, thulium, ytterbium, actinium, thorium, protactinium, uranium, neptunium, plutonium, americium, curium, berkelium, californium, einsteinium, fermium, nobelium, radium, lawrencium, rutherfordium, dubnium, seaborgium, bohrium, hassium, meitnerium, darmstadtium, roentgenium, copernicium, nihonium, flerovium, moscovium, livermorium, metallic forms thereof (e.g., zero oxidation state), ions thereof, isotopes thereof, compounds thereof, or any combination thereof.

In one or more embodiments, the chemically treated inorganic support media described and discussed in one or more embodiments herein may be used as adsorbents, and may be constructed as filters. For example, the chemically treated silica and glass in the forms of powers, particles, and beads, can be used adsorbents directly. Chemically treated silica and glass in the forms of powers, particles, and beads, can be packed inside a packed column or a filter. Such adsorbents and filters can be used to remove or recover heavy metals as well as solid particles from: (1) water including drinking water, groundwater, lakes, streams, rivers, produced water from oil and gas production, industrial wastewater, and municipal wastewater; (2) crude oil; (3) industry intermediate streams and product streams where heavy metals are present as raw materials, products, catalysts, and by-products; (4) gases such as raw natural gas, flue gases from power plants, and raw synthesis gas. In addition, such adsorbents and filters can be used a support where heavy metal catalyst such as nickel and platinum catalysts are affixed.

### Experimental

Example 1. An organosilane containing dithiocarbamate is prepared in the following method: (1) 3-aminopropyltriethoxysilane is first charged into a reactor with continuous agitation, (2) a phase-transfer catalyst, carbon disulfide and an alkyl halide such as benzyl chloride are slowly added into the reactor; (3) the by-product, hydrogen chloride while continuously removed by purging nitrogen from the bottom of the reactor; (4) the reactor is maintained at a temperature in a range from about 1° C. to about 50° C. for about 30 minutes to about 24 hours; and (5) agitation is stopped, and the top phase (product phase) is rinsed with a solvent such as water. The molar ratio of the carbon disulfide and 3-aminopropyltriethoxysilane is from about 1:99 to about 1:1, or about 1:19 to about 1:1. The molar ratio of the carbon disulfide and the alkyl halide is about 1:1 to about 1:1.5.

Example 2. An organosilane containing dithiocarbamate is prepared in the following steps: (1) 3-aminopropyltrimethoxysilane is first charged into a reactor with continuous agitation, (2) a phase-transfer catalyst(methyltrioctylammonium chloride), carbon disulfide, and an alkyl halide such as benzyl chloride are slowly added into the reactor; (3) the by-product, hydrogen chloride while continuously removed by purging nitrogen from the bottom of the reactor; (4) the reactor is maintained at a temperature in a range from about 1° C. to about 50° C. for about 30 minutes to about 24 hours; and (5) agitation is stopped, and the top phase (product phase) is rinsed with a solvent such as water. The molar ratio of the carbon disulfide and the amine group of the 3-aminopropyltrimethoxysilane is from about 1:99 to about 1:1, or about 1:19 to about 1:1. The molar ratio of the carbon disulfide and the alkyl halide is about 1:1 to about 1:1.5.

Example 3. An organosilane containing dithiocarbamate is prepared in the following steps: (1) 3-aminopropylmethyldimethoxysilane is first charged into a reactor with continuous agitation, (2) carbon disulfide and an alkyl halide such as methyl 2-bromoacetate are slowly added into the reactor; (3) the by-product, hydrogen chloride while continuously removed by purging nitrogen from the bottom of the reactor; (4) the reactor is maintained at a temperature in a range from about 1° C. to about 50° C. for about 30 minutes to about 24 hours; and (5) agitation is stopped, and the top phase (product phase) is rinsed with a solvent such as water. The molar ratio of the carbon disulfide and the amine group of the 3-aminopropylmethyldimethoxysilane is from about 1:99 to about 1:1, or about 1:19 to about 1:1. The molar ratio of the carbon disulfide and the alkyl halide is from about 1:1 to about 1:1.5.

Example 4. An organosilane containing dithiocarbamate is prepared in the following steps: (1) 3-aminopropyltriethoxysilane is first charged into a reactor, (2) carbon disulfide and an alkyl halide such as methyl 2-bromoacetate are slowly added into the reactor; (3) the by-product, hydrogen chloride while continuously removed by purging nitrogen from the bottom of the reactor; (4) the reactor is maintained at a temperature in a range from about 1° C. to about 50° C. for about 30 minutes to about 24 hours; and (5) agitation is stopped, and the top phase (product phase) is rinsed with a solvent such as water. The molar ratio of the carbon disulfide and the amine group of the 3-aminopropyltriethoxysilane is about 2:1. The molar ratio of the carbon disulfide and the alkyl halide is about 1:1.

Example 5. An organosilane containing dithiocarbamate is prepared in the following steps: (1) 3-chloropropyltrimethoxysilane is first charged into a reactor with continuous agitation, (2) a phase-transfer catalyst(methyltrioctylammonium chloride), carbon disulfide, and monoethanolamine are slowly added into the reactor; (3) the by-product, hydrogen chloride while continuously removed by purging nitrogen from the bottom of the reactor; (4) the reactor is heated or maintained at a temperature in a range from about 1° C. to about 50° C. for about 30 minutes to about 24 hours; and (5) agitation is stopped, and the top phase (product phase) is rinsed with a solvent such as water. The molar ratio of the carbon disulfide and 3-chloropropyltrimethoxysilane is from about 1:99 to about 1:1, or about 1:19 to about 1:1. The molar ratio of the carbon disulfide and the amine is from about 1:1 to about 1:1.5.

Example 6. An organosilane containing dithiocarbamate is prepared in the following steps: (1) 3-chloropropyltriethoxysilane is first charged into a reactor with continuous agitation, (2) a phase-transfer catalyst(methyltrioctylammonium chloride), carbon disulfide and an amine such as diethylamine are slowly added into the reactor; (3) the by-product, hydrogen chloride while continuously removed by purging nitrogen from the bottom of the reactor; (4) the reactor is maintained at a temperature in a range from about 1° C. to 50° C. for about 30 minutes to about 24 hours; and (5) agitation is stopped, and the top phase (product phase) is rinsed with a solvent such as water. The molar ratio of the carbon disulfide and the 3-chloropropyltriethoxysilane is from about 1:99 to about 1:1, or about 1:19 to about 1:1. The molar ratio of the carbon disulfide and the amine is from about 1:1 to about 1:1.5.

Example 7. Silica is chemically treated with the silane prepared in Example 4. First, a dithiocarbamate-containing silane prepared in Example 4 is mixed with ethanol at about 1:9 weight ratios. The resulting solution is mixed with water and acetic acid to adjust the solution pH to a range from about 4.0 to about 6.0. The silica with particle size of about 30 micron to about 200 micron is mixed with this solution for about 20 minutes. The weight ratio of silica versus the silane is about 10:1. The silica is removed from the solution by filtration and rinsed with additional ethanol. The treated silica is then dried at temperature of about 20° C. for about 24 hours.

Example 8. Silica is chemically treated with the silanes prepared in Example 6. First, a dithiocarbamate-containing silane prepared in Example 6 is mixed with ethanol at about 1:9 weight ratios. The resulting solution is mixed with water and acetic acid to adjust the solution pH to a range from about 4.0 to about 6.0. The silica with particle size of about 30 micron to about 200 micron is mixed with this solution for about 60 minutes. The weight ratio of silica versus the silane is about 10:1. The silica is removed from the solution by filtration and rinsed with additional ethanol. The treated silica is then dried at temperature of about 140° C. for about 60 minutes.

Example 9. Silica is treated with 3-aminopropyltriethoxysilane, then treated with carbon disulfide. First, 3-aminopropyltriethoxysilane is mixed with ethanol at a weight ratio of about 1:9. The resulting solution is mixed with water and acetic acid to adjust the solution pH to a range from about 4.0 to about 6.0. Silica with particle size of about 10 micron to about 30 micron is mixed with this solution for about 60 minutes at about 25° C. The silica is removed from the solution by filtration and rinsed with additional ethanol. The treated silica then dried at temperature of about 140° C. for about 60 minutes. The aminosilane treated silica is then mixed in water with a base such as sodium hydroxide. Carbon disulfide is slowly added to the solution. External cooling may be required as the reaction is exothermic. The molar ratio of carbon disulfide versus sodium ethylate is about 1:1.1. The molar ratio of carbon disulfide versus the amine group on the surface is about 1:100 to about 1:1. The silica is removed from the solution by filtration and rinsed with additional ethanol and water. The treated silica then dried at temperature of about 140° C. for about one hour.

Example 10. The resulting chemically treated silica from Example 9 can be mixed the fluids such as (1) chemical intermediates and products that contain precious metal catalysts and (2) wastewater containing heavy metals for a period of time in a range from about 1 minute to about 2 hours. The silica is then precipitated, filtered out, or separated from the fluids by a centrifuge. If the adsorbed heavy metals are precious metals, the used silica can be further processed to recover the precious heavy metals.

Example 11. Silica is treated with 3-aminopropyltrimethoxysilane, then treated with carbon disulfide. First, 3-aminopropyltrimethoxysilane is mixed with methanol at a weight ratio of about 1:9. The resulting solution is mixed with water and acetic acid to adjust the solution pH to a range from about 4.0 to about 6.0. Silica with particle size of about 10 micron to about 30 micron is mixed with this solution for about 20 minutes at about 25° C. The silica is removed from the solution by filtration and rinsed with additional methanol. The treated silica then dried at temperature of about 130° C. for about 30 minutes. The aminosilane treated silica is then mixed in water with a base such as potassium hydroxide. Carbon disulfide is slowly added to the solution. External cooling may be required as the reaction is exothermic. The molar ratio of carbon disulfide versus sodium methylate is about 1:1.1. The molar ratio of carbon disulfide versus the amine group on the surface is about 1:100 to about 1:1. The silica is removed from the solution by filtration and rinsed with additional water. The treated silica then dried at temperature of about 140° C. for about one hour.

Example 12. The resulting chemically treated silica from Example 11 can be mixed the fluids such as (1) chemical intermediates and products that contain precious metal catalysts and (2) wastewater containing heavy metals for a period of time in a range from about 1 minute to about 2 hours. The silica is then precipitated, filtered out, or separated from the fluids by a centrifuge. If the adsorbed heavy metals are precious metals, the used silica can be further processed to recover the precious heavy metals.

Example 13. Silica is treated with 3-aminopropyltriethoxysilane, then treated with carbon disulfide and an alkyl halide such as methyl 2-bromoacetate. First, 3-aminopropyltriethoxysilane is mixed with ethanol at a weight ratio of about 1:9. The resulting solution is mixed with water and acetic acid to adjust the solution pH to a range from about 4.0 to about 6.0. The silica is mixed with this solution for about 60 minutes. The silica is removed from the solution by filtration and rinsed with additional ethanol. The aminosilane treated silica is then mixed in water, then carbon disulfide and methyl 2-bromoacetate are slowly added to the solution. The reaction temperature is maintained below 60° C. and the reactor is continuously agitated for additional 12 hours after the methyl 2-bromoacetate addition is completed. The molar ratio of carbon disulfide versus methyl 2-bromoacetate is about 1:1 to about 1:1.1. The molar ratio of carbon disulfide versus the amine group on the surface is about 1:100 to about 1:1. The silica is removed from the solution by filtration and rinsed with additional water. The treated silica then dried at temperature of about 100° C. for about 2 hours.

Example 14. The resulting chemically treated silica from Example 13 can be added into a packed column. Fluids such as (1) chemical intermediates and products that contain precious metal catalysts; (2) wastewater containing heavy metals; and (3) raw natural gases and flue gases containing heavy metals flow through the packed column at about 25° C. If the adsorbed heavy metals are precious metals, the used silica can be further processed to recover the precious heavy metals.

Example 15. Glass in one or more forms of powder, bead, fiber, filter, non-woven fabric, or combinations thereof is treated with 3-aminopropyltriethoxysilane, then treated with carbon disulfide. First, 3-aminopropyltriethoxysilane is mixed with ethanol at a weight ratio of about 1:99 to about 1:9. The resulting solution is mixed with water and acetic acid to adjust the solution pH to a range from about 4.0 to about 6.0. The glass is mixed or sprayed on with this solution for about 0.1 minutes to about 20 minutes. The glass is removed from the solution and rinsed with additional ethanol. The treated glass then dried at temperature in a range from about 10° C. to about 140° C. for about 5 minutes to about 1 hour. The aminosilane treated glass is then mixed in water with a base such as sodium hydroxide. Carbon disulfide is slowly added to the solution. External cooling may be required as the reaction is exothermic. The molar ratio of carbon disulfide versus sodium ethylate is about 1:1.1. The molar ratio of carbon disulfide versus the amine group on the surface is about 1:100 to about 1:1. The glass is removed from the solution by filtration and rinsed with additional water. The treated glass then dried at temperature in a range from about 40° C. to about 100° C. for about 5 minutes to about 2 hours.

Example 16. The resulting chemically treated glass from Example 15 in the forms of powders, beads, and fibers can be mixed the fluids such as (1) chemical intermediates and products that contain precious metal catalysts; (2) wastewater containing heavy metals; and (3) raw natural gases and flue gases containing heavy metals for a period of time in a range from about 1 minute to about 2 hours. The glass is then precipitated, filtered out, or separated from the fluids by a centrifuge. If the adsorbed heavy metals are precious metals, the used glass can be further processed to recover the precious heavy metals.

Example 17. Silica is chemically treated with 3-thiocyanatopropyltrimethoxysilane. about grams of 3-First, 10 thiocyanatopropyltrimethoxysilane is mixed with about 90 grams of methanol. Acetic acid and water are added to the resulting solution to adjust the solution pH to a range from about 4.0 to about 6.0. About 50 grams of silica with particle size of about 30-60 micron is mixed with this solution for about 20 minutes. The silica is removed from the solution by filtration and rinsed with additional methanol. The treated silica is then dried at temperature in a range from about 140° C. for about 60 minutes.

Embodiments of the present disclosure further relate to any one or more of the following Paragraphs 1-56:
1. An organosilane compound represented by Formulas (5a), (5b), (5c), (5d), (5e), (5b), or (5f), wherein: each of X₁, X₂, and X₃ is independently a hydrolysable group selected from an alkoxy group, an acyloxy group, a halogen, or a hydride; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.
2. The organosilane compound according to Paragraph 1, wherein the organosilane compound represented by Formula (5a) is represented by Formula (6).
3. The organosilane compound according to Paragraph 1, wherein the organosilane compound represented by Formula (5a) is represented by Formula (7).
4. The organosilane compound according to Paragraph 1, wherein the organosilane compound represented by Formula (5a) is represented by Formula (8).
5. The organosilane compound according to Paragraph 1, wherein the organosilane compound represented by Formula (5a) is represented by Formula (9).
6. The organosilane compound according to Paragraph 1, wherein the organosilane compound represented by Formula (5b) is represented by Formula (10).
7. A functionalized inorganic matrix comprising an inorganic support media and the organosilane compound according to any one of Paragraphs 1-6 and represented by one or more of Formulas (5a), (5b), (5c), (5d), (5e), (5f), (6), (7), (8), (9), and (10), wherein the organosilane compound is disposed on a surface of the inorganic support media.
8. The functionalized inorganic matrix according to Paragraph 7, wherein the inorganic support media is selected from the group consisting of silica, quartz, glass, sand, diatomite, aluminum oxide, alumina, aluminosilicate, metallic substrates, iron substrates, aluminum substrates, and any combination thereof.
9. The functionalized inorganic matrix according to Paragraph 8, wherein the inorganic support media comprises silica, and wherein the silica is selected from the group consisting of silica gel, amorphous silica, fumed silica, precipitated silica, and any combination thereof.
10. The functionalized inorganic matrix of Paragraph 8, wherein the inorganic support media comprises glass, and wherein the glass is selected from the group consisting of powdered glass, glass beads, glass fibers, glass filter, non-woven glass fabric, and any combination thereof.
11. A filter system, comprising: a filter unit; and the functionalized inorganic matrix according to any one of Paragraphs 7-10 contained within the filter unit.
12. The filter system according to Paragraph 11, wherein the filter system is configured to support a heavy metal catalyst or separate a heavy metal from a heavy metal-contaminated fluid by exposing the heavy metal-contaminated fluid to the functionalized inorganic matrix and producing a treated fluid and the heavy metal that is captured, or adsorbed onto the surface of the functionalized inorganic matrix.
13. The filter system according to Paragraph 12, wherein the heavy metal is selected from the group consisting of titanium, vanadium, chromium, manganese, iron, cobalt, nickel, copper, zinc, gallium, germanium, arsenic, zirconium, niobium, molybdenum, technetium, ruthenium, rhodium, palladium, silver, cadmium, indium, tin, tellurium, lutetium, hafnium, tantalum, tungsten, rhenium, osmium, iridium, platinum, gold, mercury, thallium, lead, bismuth, polonium, astatine, lanthanum, cerium, praseodymium, neodymium, promethium, samarium, europium, gadolinium, terbium, dysprosium, holmium, erbium, thulium, ytterbium, actinium, thorium, protactinium, uranium, neptunium, plutonium, americium, curium, berkelium, californium, einsteinium, fermium, nobelium, radium, lawrencium, rutherfordium, dubnium, seaborgium, bohrium, hassium, meitnerium, darmstadtium, roentgenium, copernicium, nihonium, flerovium, moscovium, livermorium, metallic forms thereof, ions thereof, isotopes thereof, compounds thereof, and any combination thereof.
14. The filter system according to any one of Paragraphs 11-13, wherein the heavy metal-contaminated fluid is in a state of mater of liquid, gas, or a mixture thereof; and wherein the heavy metal-contaminated fluid is selected from the group consisting of water, drinking water, potable water, non-potable water, groundwater, water from oil and gas production, industrial wastewater, municipal wastewater, oil, crude oil, oil waste stream, industrial intermediate streams, product streams containing heavy metals, product streams containing heavy metal catalysts or by-products, natural gas, flue gas, synthesis gas or syngas (mixture of CO and H2), and any combination thereof.
15. A method of preparing the organosilane compound according to any one of Paragraphs 1-14, comprising: combining an aminosilane, an alkyl halide, carbon disulfide, a base, a solvent, and an optional phase-transfer catalyst to produce the organosilane compound, wherein: the aminosilane is represented by Formulas (11a), (11b), and (11c) and the alkyl halide is represented by Formula (12), wherein: each of X₁, X₂, and X₃ is independently a hydrolysable group selected from an alkoxy group, an acyloxy group, a halogen, or a hydride; X₄ is fluoride, chloride, bromide, or iodide; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.
16. The method according to Paragraph 15, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, and any combination thereof.
17. The method according to Paragraph 15 or 16, wherein the solvent is selected from the group consisting of methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, and any combination thereof.
18. The method according to any one of Paragraphs 15-17, wherein the phase-transfer catalyst is selected from the group consisting of tributyl(tetradecyl) phosphonium chloride, trioctyl(octadecyl) phosphonium iodide, tetramethylammonium chloride, tetramethylammonium bromide, tetramethylammonium iodide, tetramethylammonium hydroxide, tetraethylammonium chloride, tetraethylammonium bromide, tetraethylammonium iodide, tetraethylammonium hydroxide, tetrabutylammonium chloride, tetrabutylammonium bromide, tetrabutylammonium iodide, tetrabutylammonium hydroxide, methyltributylammonium chloride, methyltributylammonium bromide, methyltributylammoniumiodide, methyltributylammonium hydroxide, tetraoctylammonium chloride, tetraoctylammonium bromide, tetraoctylammonium iodide, tetraoctylammonium hydroxide, methyltrioctylammonium chloride, methyltrioctylammonium bromide, methyltrioctylammonium iodide, methyltriocty lammonium hydroxide, benzyltrimethylammonium chloride, benzyltrimethylammonium bromide, benzyltriethylammonium chloride, benzyltributylammonium chloride, dibenzyldimethylammonium chloride, dibenzyldimethylammonium bromide, dibenzyldiethylammonium chloride, dibenzyldibutylammonium chloride, tetrabutylphosphonium bromide, tetrabutylphosphonium chloride, aqueous solutions thereof, and any combination thereof.
19. A method of preparing a functionalized inorganic matrix comprising the organosilane compound represented by one or more of Formulas (5a), (5b), (5c), (5d), (5e), (5f), (6), (7), (8), (9), and (10), comprising: combining the organosilane compound, an optional solvent, water, and an acid to form a mixture having a pH value of about 1.0 to about 6.0; exposing an inorganic support media to the mixture; and drying the mixture on the inorganic support media to form the functionalized inorganic matrix.
20. The method according to Paragraph 19, wherein the inorganic support media is exposed to the mixture by: dipping or submerging the inorganic support media into the mixture, or spraying the mixture on to the inorganic support media by a one or more techniques selected from ultrasonic nebulization, pressure atomization, or electrostatic atomization.
21. An organosilane compound represented by Formula (13), wherein: each of X₁, X₂, and X₃ is independently a hydrolysable group selected from an alkoxy group, an acyloxy group, a halide, or a hydride; R₁ is selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and each of R₂ and R₃ is independently selected from a hydrogen, a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.
22. The organosilane compound according to Paragraph 21, wherein the organosilane compound represented by Formula (13) is represented by Formula (14).
23. The organosilane compound according to Paragraph 21, wherein the organosilane compound represented by Formula (13) is represented by Formula (15).
24. The organosilane compound according to Paragraph 21, wherein the organosilane compound represented by Formula (13) is represented by Formula (16).
25. The organosilane compound according to Paragraph 21, wherein the organosilane compound represented by Formula (13) is represented by Formula (17).
26. The organosilane compound according to Paragraph 21, wherein the organosilane compound represented by Formula (13) is represented by Formula (18).
27. A functionalized inorganic matrix comprising an inorganic support media and the organosilane compound according to any one of Paragraphs 21-26 and represented by one or more of Formulas (13), (14), (15), (16), (17), and (18), wherein the organosilane compound is disposed on a surface of the inorganic support media.
28. The functionalized inorganic matrix according to Paragraph 27, wherein the inorganic support media is selected from the group consisting of silica, quartz, glass, sand, diatomite, aluminum oxide, alumina, aluminosilicate, metallic substrates, iron substrates, aluminum substrates, and any combination thereof.
29. The functionalized inorganic matrix according to Paragraph 28, wherein the inorganic support media comprises silica, and wherein the silica is selected from the group consisting of silica gel, amorphous silica, fumed silica, precipitated silica, and any combination thereof.
30. The functionalized inorganic matrix according to Paragraph 28, wherein the inorganic support media comprises glass, and wherein the glass is selected from the group consisting of powdered glass, glass beads, glass fibers, glass filter, non-woven glass fabric, and any combination thereof.
31. A filter system, comprising: a filter unit; and the functionalized inorganic matrix according to any one of Paragraphs 27-30 contained within the filter unit.
32. The filter system according to Paragraph 31, wherein the filter system is configured to support a heavy metal catalyst or separate a heavy metal from a heavy metal-contaminated fluid by exposing the heavy metal-contaminated fluid to the functionalized inorganic matrix and producing a treated fluid and the heavy metal.
33. The filter system according to Paragraph 32, wherein the heavy metal is selected from the group consisting of titanium, vanadium, chromium, manganese, iron, cobalt, nickel, copper, zinc, gallium, germanium, arsenic, zirconium, niobium, molybdenum, technetium, ruthenium, rhodium, palladium, silver, cadmium, indium, tin, tellurium, lutetium, hafnium, tantalum, tungsten, rhenium, osmium, iridium, platinum, gold, mercury, thallium, lead, bismuth, polonium, astatine, lanthanum, cerium, praseodymium, neodymium, promethium, samarium, europium, gadolinium, terbium, dysprosium, holmium, erbium, thulium, ytterbium, actinium, thorium, protactinium, uranium, neptunium, plutonium, americium, curium, berkelium, californium, einsteinium, fermium, nobelium, radium, lawrencium, rutherfordium, dubnium, seaborgium, bohrium, hassium, meitnerium, darmstadtium, roentgenium, copernicium, nihonium, flerovium, moscovium, livermorium, metallic forms thereof, ions thereof, isotopes thereof, compounds thereof, and any combination thereof.
34. The filter system according to any one of Paragraphs 32-34, wherein the heavy metal-contaminated fluid is in a state of mater of liquid, gas, or a mixture thereof; and wherein the metal-contaminated fluid is selected from the group consisting of water, drinking water, potable water, non-potable water, groundwater, water from oil and gas production, industrial wastewater, municipal wastewater, oil, crude oil, oil waste stream, industrial intermediate streams, product streams containing heavy metals, product streams containing catalysts or by-products, natural gas, flue gas, synthesis gas or syngas (mixture of CO and H2), and any combination thereof.
35. A method of preparing the organosilane compound according to any one of Paragraphs 21-34, comprising: combining a halogensilane, an amine-containing compound, carbon disulfide, a base, a solvent, and a phase-transfer catalyst to produce the organosilane compound, wherein: the halogensilane is represented by Formula (19) and the amine-containing compound is represented by Formula (20), wherein: each of X₁, X₂, and X₃ is independently a hydrolysable group selected from an alkoxy group, an acyloxy group, a halide, or a hydride; X₄ is fluoride, chloride, bromide, or iodide; R₁ is selected from a saturated or unsaturated, linear or branched, substituted or unsubstituted, hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and each of R₂ and R₃ is independently is selected from a hydrogen; a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; a linear or branched hydrocarbon chain with at least one hydroxyl group wherein the number of carbon atoms ranges from 1 to 10; or a linear or branched hydrocarbon chain with at least one amino group wherein the number of carbon atoms ranges from 1 to 10.
36. The method according to Paragraph 35, wherein the amine-containing compound is selected from the group consisting of ammonia, monoethanolamine, diethanolamine, diisopropanolamine, diglycolamine, iminodiacetic acid, and any combination thereof.
37. The method according to Paragraph 35 or 36, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, and any combination thereof.
38. The method according to any one of Paragraphs 35-37, wherein the solvent is selected from the group consisting of methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, and any combination thereof.
39. The method according to any one of Paragraphs 35-38, wherein the phase-transfer catalyst is selected from the group consisting of tributyl(tetradecyl) phosphonium chloride, trioctyl(octadecyl) phosphonium iodide, tetramethylammonium chloride, tetramethylammonium bromide, tetramethylammonium iodide, tetramethylammonium hydroxide, tetraethylammonium chloride, tetraethylammonium bromide, tetraethylammonium iodide, tetraethylammonium hydroxide, tetrabutylammonium chloride, tetrabutylammonium bromide, tetrabutylammonium iodide, tetrabutylammonium hydroxide, methyltributylammonium chloride, methyltributylammonium bromide, methyltributylammoniumiodide, methyltributylammonium hydroxide, tetraoctylammonium chloride, tetraoctylammonium bromide, tetraoctylammonium iodide, tetraoctylammonium chloride, hydroxide, methyltrioctylammonium methyltrioctylammonium bromide, methyltrioctylammonium iodide, methyltriocty lammonium hydroxide, benzyltrimethylammonium chloride, benzyltrimethylammonium bromide, benzyltriethylammonium chloride, benzyltributylammonium chloride, dibenzyldimethylammonium chloride, dibenzyldimethylammonium bromide, dibenzyldiethylammonium chloride, dibenzyldibutylammonium chloride, tetrabutylphosphonium bromide, tetrabutylphosphonium chloride, aqueous solutions thereof, and any combination thereof.
40. A method of preparing a functionalized inorganic matrix comprising the organosilane compound according to any one of Paragraphs 21-26 and represented by one or more of Formulas (13), (14), (15), (16), (17), and (18), comprising: combining the organosilane compound, an optional solvent, water, and an acid to form a mixture having a pH value of about 1.0 to about 6.0; exposing an inorganic support media to the mixture; and drying the mixture on the inorganic support media to form the functionalized inorganic matrix.
41. The method according to Paragraph 40, wherein the inorganic support media is exposed to the mixture by: dipping or submerging the inorganic support media into the mixture, or spraying the mixture on to the inorganic support media.
42. A method for preparing a functionalized inorganic matrix, comprising: combining an inorganic support media, an amine-containing silane, water, an acid, carbon disulfide, one or more solvents, an optional base, and an optional alkyl halide to produce the functionalized inorganic matrix, wherein: the amine-containing silane is represented by Formula (21a), Formula (21b), or Formula (21b); and the optional alkyl halide is represented by Formula (22), wherein: each of X₁, X₂, and X₃ is independently a hydrolysable group selected from an alkoxy group, an acyloxy group, a halide, or a hydride; X₄ is fluoride, chloride, bromide, or iodide; each R₁ is independently selected from hydrogen; a linear or branched alkyl group wherein the number of carbon atoms ranges from 1 to 10; a cyclic alkyl group wherein the number of carbon atoms ranges from 3 to 10; an aromatic group wherein the number of carbon atoms ranges from 6 to 10; a saturated or unsaturated heterocyclic group wherein the number of carbon atoms ranges from 3 to 10 and the number of heteroatoms in the heterocyclic ring of the heterocyclic group is 1, 2, or 3; or an alkylamino group wherein the number of carbon atoms ranges from 1 to 10; and each of R₀, R₂, R₃, and R₄ is independently selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10.
43. The method according to Paragraph 42, wherein the inorganic support media is selected from the group consisting of silica, quartz, glass, sand, diatomite, aluminum oxide, alumina, aluminosilicate, metallic substrates, iron substrates, aluminum substrates, and any combination thereof.
44. The method according to Paragraph 43, wherein inorganic support media comprises silica, and wherein the silica is selected from the group consisting of silica gel, amorphous silica, fumed silica, precipitated silica, and any combination thereof.
45. The method according to Paragraph 43, wherein inorganic support media comprises glass, and wherein the glass is selected from the group consisting of powdered glass, glass beads, glass fibers, glass filter, non-woven glass fabric, and any combination thereof.
46. The method according to any one of Paragraphs 42-45, wherein the amine-containing silane is selected from the group consisting of 3-aminopropyltriethoxysilane, 3-aminopropyltrimethoxysilane, 4-aminobutyltriethoxysilane, 4-amino-3,3-dimethylbutyltrimethoxysilane, n-(2-aminoethyl)-3-aminopropyltriethoxysilane, 3-(m-aminophenoxy) propyltrimethoxysilane, aminophenyltrimethoxysilane, aminophenyltriethoxysilane, 3-aminopropyltris(methoxyethoxyethoxy) silane, 11-aminoundecyltriethoxysilane, 3-aminopropylsilanetriol, 4-amino-3,3-dimethylbutylmethyldimethoxysilane, 3-aminopropylmethyldiethoxysilane, 1-amino-2-(dimethylethoxysilyl)propane, 3-aminopropyldiisopropylethoxysilane, n-(2-aminoethyl)-3-aminopropyltrimethoxysilane, n-(6-aminohexyl)aminomethyltriethoxysilane, n-(2-aminoethyl)-11-aminoundecyltrimethoxysilane, n-(2-aminoethyl)-3-aminopropylsilanetriol, n-(2-aminoethyl)-3-aminoisobutylmethyldimethoxysilane, n-(2-aminoethyl)-3-aminopropylmethyldiethoxysilane, n-(2-aminoethyl)-3-aminopropylmethyldimethoxysilane, (3-trimethoxysilylpropyl) diethylenetriamine, n-(2-aminoethyl)-3-aminoisobutyldimethylmethoxysilane, 3-(n-allylamino) propyltrimethoxysilane, n-butylaminopropyltrimethoxysilane, t-butylaminopropyltrimethoxysilane, (3-(n-ethylamino)isobutyl)methyldiethoxysilane, (3-(n-ethylamino)isobutyl)trimethoxysilane, n-methylaminopropylmethyldimethoxysilane, n-methylaminopropyltrimethoxysilane, (phenylaminomethyl)methyldimethoxysilane, n-phenylaminomethyltriethoxysilane, n-phenylaminopropyltrimethoxysilane, and any combination thereof.
47. The method according to any one of Paragraphs 42-46, wherein the acid is selected from the group consisting of hydrochloric acid, sulfuric acid, phosphoric acid, nitric acid, acetic acid, boric acid, hydrofluoric acid, oxalic acid, citric acid, toluenesulfonic acid, carbonic acid, salts thereof, and any combination thereof.
48. The method according to any one of Paragraphs 42-47, further comprising: combining the amine-containing silane, a first solvent, the water, and the acid to form a first mixture having a pH value of about 1.0 to about 6.0; exposing the inorganic support media to the first mixture; at least partially drying the first mixture on the inorganic support media to form an intermediate product; and exposing the intermediate product to a second mixture comprising a second solvent, carbon disulfide, and the base to produce the functionalized inorganic matrix.
49. The method according to Paragraph 48, wherein the second mixture further comprises an alkyl halide.
50. The method according to Paragraph 48 or 49, wherein the inorganic support media is exposed to the first mixture by: dipping or submerging the inorganic support media into the first mixture, or spraying the first mixture on to the inorganic support media.
51. The method according to Paragraph 48 or 49, wherein the intermediate product is exposed to the second mixture by: dipping or submerging the intermediate product into the second mixture, or spraying the second mixture on to the intermediate product.
52. The method according to any one of Paragraphs 48-51, wherein the solvent is selected from the group consisting of methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, and any combination thereof.
53. The method according to any one of Paragraphs 48-52, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, and any combination thereof.
54. A method of preparing a functionalized inorganic matrix, comprising: combining an inorganic support media, a silane, water, an acid, and a solvent to produce the functionalized inorganic matrix, wherein the silane is selected from 3-thiocyanatopropyltriethoxysilane, 3-thiocyanatopropyltrimethoxysilane, 3-octanoylthio-1-propyltriethoxysilane, 3-octanoylthio-1-propyltrimethoxysilane, and an organosilane represented by Formula (23), wherein x is in a range from 1.0 to 8.0; and each R is independently a methyl group or an ethyl group.
55. The method according to Paragraph 54, wherein the inorganic support media is selected from the group consisting of silica, quartz, glass, sand, diatomite, aluminum oxide, alumina, aluminosilicate, metallic substrates, iron substrates, aluminum substrates, and any combination thereof.
56. The method according to Paragraph 54 or 55, wherein the acid is selected from the group consisting of hydrochloric acid, sulfuric acid, phosphoric acid, nitric acid, acetic acid, boric acid, hydrofluoric acid, oxalic acid, citric acid, toluenesulfonic acid, carbonic acid, salts thereof, and any combination thereof.
57. The method according to any one of Paragraphs 54-56, wherein the solvent is selected from the group consisting of methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, and any combination thereof.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated.

Certain embodiments and features have been described using a set of numerical minimum values and a set of numerical maximum values. It should be appreciated that ranges including the combination of any two values, e.g., the combination of any minimum value with any maximum value, the combination of any two minimum values, and/or the combination of any two maximum values are contemplated unless otherwise indicated. Certain minimum values, maximum values, and ranges appear in one or more claims below.

1-20. (canceled)

21. An organosilane compound represented by Formula (13): 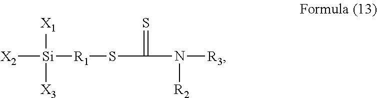
wherein:
each of X₁, X₂, and X₃ is independently a hydrolysable group selected from an alkoxy group, an acyloxy group, a halide, or a hydride;
R₁ is selected from a saturated or unsaturated, linear or branched, substituted or unsubstituted hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and
each of R₂ and R₃ is independently selected from a hydrogen, a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; or a linear or branched hydrocarbon chain with at least one hydroxyl group wherein the number of carbon atoms ranges from 1 to 10.

22. The organosilane compound of claim 21, wherein the organosilane compound represented by Formula (13) is represented by Formula (14):

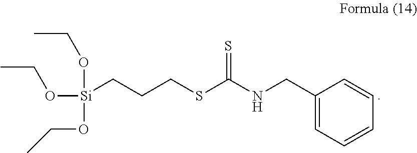 [SMILES: CCO[Si](CCCSC(=S)NCc1ccccc1)(OCC)OCC]

23. The organosilane compound of claim 21, wherein the organosilane compound represented by Formula (13) is represented by Formula (15):

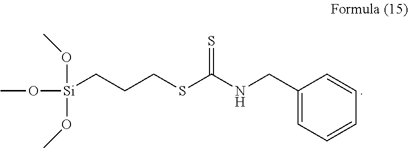 [SMILES: CO[Si](CCCSC(=S)NCc1ccccc1)(OC)OC]

24. The organosilane compound of claim 21, wherein the organosilane compound represented by Formula (13) is represented by Formula (16):

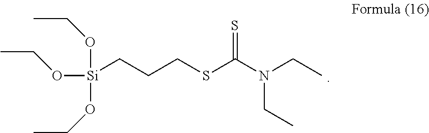 [SMILES: CCO[Si](CCCSC(=S)N(CC)CC)(OCC)OCC]

25. The organosilane compound of claim 21, wherein the organosilane compound represented by Formula (13) is represented by Formula (17):

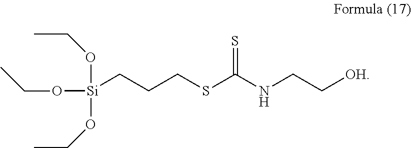 [SMILES: CCO[Si](CCCSC(=S)NCCO)(OCC)OCC]

26. The organosilane compound of claim 21, wherein the organosilane compound represented by Formula (13) is represented by Formula (18):

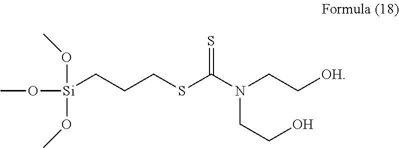 [SMILES: CO[Si](CCCSC(=S)N(CCO)CCO)(OC)OC]

27. A functionalized inorganic matrix comprising an inorganic support media and the organosilane compound of claim 21 and represented by Formula (13), wherein the organosilane compound is disposed on a surface of the inorganic support media.

28. The functionalized inorganic matrix of claim 27, wherein the inorganic support media is selected from the group consisting of silica, quartz, glass, sand, diatomite, aluminum oxide, alumina, aluminosilicate, metallic substrates, iron substrates, aluminum substrates, and any combination thereof.

29. The functionalized inorganic matrix of claim 28, wherein the inorganic support media comprises silica, and wherein the silica is selected from the group consisting of silica gel, amorphous silica, fumed silica, precipitated silica, and any combination thereof.

30. The functionalized inorganic matrix of claim 28, wherein the inorganic support media comprises glass, and wherein the glass is selected from the group consisting of powdered glass, glass beads, glass fibers, glass filter, non-woven glass fabric, and any combination thereof.

31. A filter system, comprising:
a filter unit; and
the functionalized inorganic matrix of claim 27 contained within the filter unit.

32. The filter system of claim 31, wherein the filter system is configured to support a heavy metal catalyst or separate a heavy metal from a heavy metal-contaminated fluid by exposing the heavy metal-contaminated fluid to the functionalized inorganic matrix and producing a treated fluid and the heavy metal.

33. The filter system of claim 32, wherein the heavy metal is selected from the group consisting of titanium, vanadium, chromium, manganese, iron, cobalt, nickel, copper, zinc, gallium, germanium, arsenic, zirconium, niobium, molybdenum, technetium, ruthenium, rhodium, palladium, silver, cadmium, indium, tin, tellurium, lutetium, hafnium, tantalum, tungsten, rhenium, osmium, iridium, platinum, gold, mercury, thallium, lead, bismuth, polonium, astatine, lanthanum, cerium, praseodymium, neodymium, promethium, samarium, europium, gadolinium, terbium, dysprosium, holmium, erbium, thulium, ytterbium, actinium, thorium, protactinium, uranium, neptunium, plutonium, americium, curium, berkelium, californium, einsteinium, fermium, nobelium, radium, lawrencium, rutherfordium, dubnium, seaborgium, bohrium, hassium, meitnerium, darmstadtium, roentgenium, copernicium, nihonium, flerovium, moscovium, livermorium, metallic forms thereof, ions thereof, isotopes thereof, compounds thereof, and any combination thereof.

34. The filter system of claim 32, wherein the heavy metal-contaminated fluid is in a state of mater of liquid, gas, or a mixture thereof; and wherein the metal-contaminated fluid is selected from the group consisting of water, drinking water, potable water, non-potable water, groundwater, water from oil and gas production, industrial wastewater, municipal wastewater, oil, crude oil, oil waste stream, industrial intermediate streams, product streams containing heavy metals, product streams containing catalysts or by-products, natural gas, flue gas, synthesis gas or syngas (mixture of CO and H2), and any combination thereof.

35. A method of preparing the organosilane compound of claim 21, comprising:
combining a halogensilane, an amine-containing compound, carbon disulfide, a base, a solvent, and a phase-transfer catalyst to produce the organosilane compound, wherein:
the halogensilane is represented by Formula (19) and the amine-containing compound is represented by Formula (20): 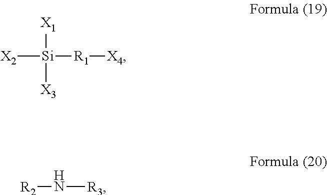
wherein:
each of X₁, X₂, and X₃ is independently a hydrolysable group selected from an alkoxy group, an acyloxy group, a halide, or a hydride;
X₄ is fluoride, chloride, bromide, or iodide;
R₁ is selected from a saturated or unsaturated, linear or branched, substituted or unsubstituted, hydrocarbon chain wherein the number of carbon atoms ranges from 1 to 10; or a saturated or unsaturated, carbocyclic or heterocyclic ring wherein the number of carbon atoms ranges from 1 to 10 and the number of heteroatoms in the heterocyclic ring of the heterocyclic group is 1, 2, or 3; and
each of R₂ and R₃ is independently is selected from a hydrogen; a saturated or unsaturated, linear or branched, substituted or unsubstituted, hydrocarbon chain wherein the number of carbon atoms ranges from 1 to 10; a saturated or unsaturated carbocyclic or heterocyclic ring wherein the number of carbon atoms ranges from 1 to 10; a linear or branched hydrocarbon chain with at least one hydroxyl group wherein the number of carbon atoms ranges from 1 to 10; or a linear or branched hydrocarbon chain with at least one amino group wherein the number of carbon atoms ranges from 1 to 10.

36. The method of claim 35, wherein the amine-containing compound is selected from the group consisting of ammonia, monoethanolamine, diethanolamine, diisopropanolamine, diglycolamine, iminodiacetic acid, and any combination thereof.

37. The method of claim 35, wherein the base is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, lithium carbonate, lithium bicarbonate, sodium carbonate, sodium bicarbonate, potassium carbonate, potassium bicarbonate, rubidium carbonate, rubidium bicarbonate, cesium carbonate, cesium bicarbonate, lithium methoxide, sodium methoxide, potassium methoxide, rubidium methoxide, cesium methoxide, magnesium methoxide, calcium methoxide, strontium methoxide, barium methoxide, lithium ethoxide, sodium ethoxide, potassium ethoxide, rubidium ethoxide, cesium ethoxide, magnesium ethoxide, calcium ethoxide, strontium ethoxide, barium ethoxide, and any combination thereof.

38. The method of claim 35, wherein the solvent is selected from the group consisting of methanol, ethanol, isopropyl alcohol, propyl alcohol, dichloromethane, tetrahydrofuran, ethyl acetate, acetonitrile, dimethylformamide, dimethyl sulfoxide, dimethylacetamide, 1-methyl-2-pyrrolidinoneacetone, ethylene glycol, diethylene glycol, ethylene carbonate, propylene carbonate, pyridine, and any combination thereof.

39. The method of claim 35, wherein the phase-transfer catalyst is selected from the group consisting of tributyl(tetradecyl) phosphonium chloride, trioctyl(octadecyl) phosphonium iodide, tetramethylammonium chloride, tetramethylammonium bromide, tetramethylammonium iodide, tetramethylammonium hydroxide, tetraethylammonium chloride, tetraethylammonium bromide, tetraethylammonium iodide, tetraethylammonium hydroxide, tetrabutylammonium chloride, tetrabutylammonium bromide, tetrabutylammonium iodide, tetrabutylammonium hydroxide, methyltributylammonium chloride, methyltributylammonium bromide, methyltributylammoniumiodide, methyltributylammonium hydroxide, tetraoctylammonium chloride, tetraoctylammonium bromide, tetraoctylammonium iodide, tetraoctylammonium hydroxide, methyltrioctylammonium chloride, methyltrioctylammonium bromide, methyltrioctylammonium iodide, methyltriocty lammonium hydroxide, benzyltrimethylammonium chloride, benzyltrimethylammonium bromide, benzyltriethylammonium chloride, benzyltributylammonium chloride, dibenzyldimethylammonium chloride, dibenzyldimethylammonium bromide, dibenzyldiethylammonium chloride, dibenzyldibutylammonium chloride, tetrabutylphosphonium bromide, tetrabutylphosphonium chloride, aqueous solutions thereof, and any combination thereof.

40. A method of preparing a functionalized inorganic matrix comprising the organosilane compound of claim 21 and represented by Formula (13), comprising:
combining the organosilane compound, an optional solvent, water, and an acid to form a mixture having a pH value of about 1.0 to about 6.0;
exposing an inorganic support media to the mixture; and
drying the mixture on the inorganic support media to form the functionalized inorganic matrix.

41-57. (canceled)
